(19) United States
(12) Patent Application Publication
(10) Pub. No.: US 2003/0151185 A1
(43) Pub. Date: Aug. 14, 2003

(54) Adjustable width wedge clamp apparatus

(76) Inventor: Frans Feyter, Fort MacLeod (CA)

Correspondence Address: STURM & FIX LLP, 206 SIXTH AVENUE, SUITE 1213, DES MOINES, IA, 50309-4076, US

(21) Appl. No.: 10/068,132

(22) Filed: Feb. 8, 2002

(51) Int. Cl. B23Q 3/02

(52) U.S. Cl. 269/138

(57) ABSTRACT

An adjustable width wedge clamp apparatus (10) for use in locking channels having different dimensions wherein the apparatus (10) includes a base unit (11) comprising an elongated trapezoidal shaped base member (20) having an angled rear face (24) that slidably engages a complimentary angled face (39) on a wedge element (38) that depends downwardly from the intermediate portion (31) of a wedge body member (30) having a raised collar element (35) provided with a stepped shoulder bore (36) that is dimensioned to receive a locking screw member (40) and an apertured locking disk member (46) that slidably receives a portion of the locking screw member (40) to permit the wedge body member (30) to be laterally shifted relative to the base member (20).

### BACKGROUND OF THE INVENTION

### CROSS REFERENCE TO RELATED APPLICATIONS

Not applicable.

1. Field of the Invention

The present invention relates to the field of clamping mechanisms in general and in particular to an adjustable width wedge clamp apparatus that serves to fasten jig hardware accessories onto a metal table surface and as a lumber stop.

2. Description of Related Art

As can be seen by reference to the following U.S. Pat. Nos. 5,324,013; 5,984,292; 5,608,970; and 5,941,514, the prior art is replete with myriad and diverse clamping mechanisms employed for a wide variety of purposes.

While all of the aforementioned prior art constructions are more than adequate for the basic purpose and function for which they have been specifically designed, they are uniformly deficient with respect to their failure to provide a simple, efficient, and practical adjustable width wedge clamp apparatus that can be employed in different sized locking channels on a number of worktable surfaces to effect the clamping of mated work pieces in the fabrication of roof truss frameworks or the like.

As most carpenters and general contractors are all too well aware, the fabrication of roof trusses is a time consuming affair and unfortunately most clamping mechanisms used to brace and hold the truss are only designed to be employed with a specific width locking channel.

As a consequence of the foregoing situation, there has existed a longstanding need in the house building trades for a new and improved adjustable width clamping apparatus that can be readily installed in locking channels having different dimensions; and, the provision of such an arrangement is the stated objective of the present invention.

### BRIEF SUMMARY OF THE INVENTION

Briefly stated, the adjustable width wedge clamp apparatus that forms the basis of the present invention comprises in general a base unit, a wedge unit and a locking unit that captively engages the wedge unit to the base unit in a laterally adjustable fashion.

As will be explained in greater detail further on in the specification, the locking unit includes a locking screw member having an enlarged contoured head which includes a vertical post element that rests on top of an outwardly projecting collar element, and a locking side member having an elongated slot dimensioned to slidably receive the vertical post element.

In addition, the wedge unit includes a wedge body member having a downwardly depending wedge element provided with an angled face and a raised collar element provided with a stepped shoulder base dimensioned to loosely receive the locking screw member and captively receive the locking disk member so that the locking unit is operatively connected to the wedge unit.

Furthermore, the base unit includes: an elongated base member having an angled rear face that is slidably engagable with the angled face on the wedge body member, and a vertical threaded aperture that is adapted to receive the locking screw member while allowing for the lateral adjustability of the wedge unit relative to the base unit.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the wedge clamp apparatus that forms the basis of the present invention;

FIG. 2 is an exploded perspective view of the wedge clamp apparatus;

FIG. 3 is a cross-sectional view depicting the clamp unit fully engaged with the base unit;

FIG. 4 is a cross-sectional view depicting the clamp unit fully engaged with the base unit.

### DETAILED DESCRIPTION OF THE INVENTION

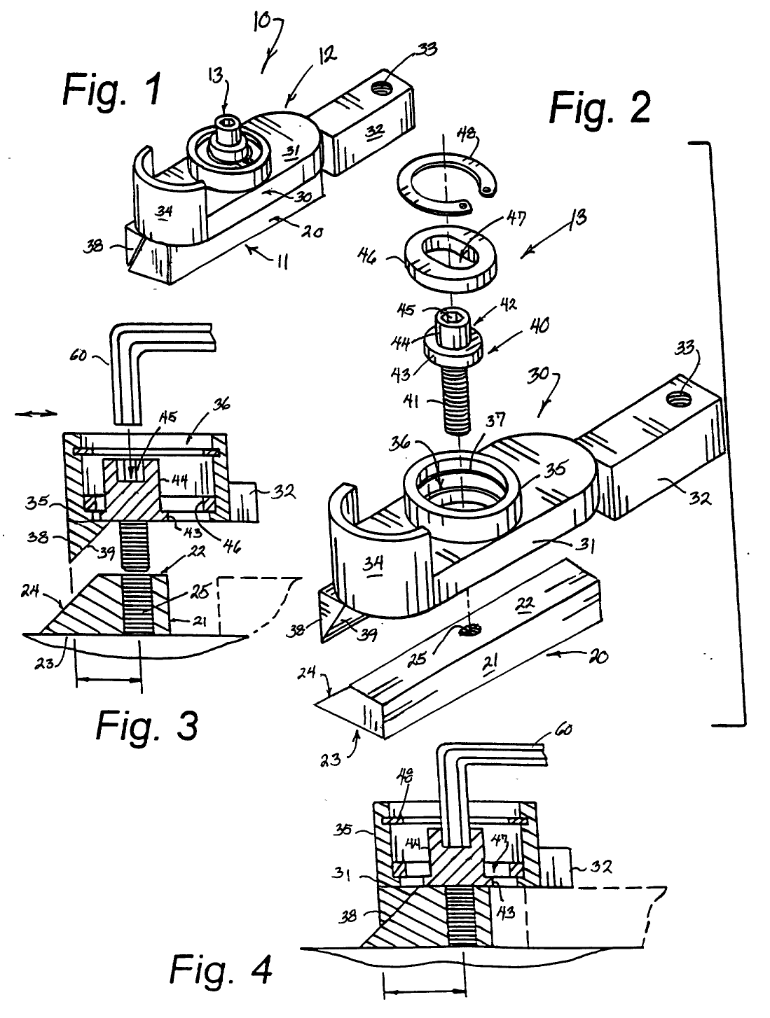

As can be seen by reference to the drawings, and in particular to FIG. 1, the wedge clamp apparatus that forms the basis of the present invention is designated generally by the reference number 10, The apparatus 10 comprises in general a base unit 11, a wedge unit 12, and a locking unit 13. These units will now be described in seriatim fashion.

As can best be seen by reference to FIGS. 2 through 4, the base unit 11 comprises an elongated base member 20 having a generally trapezoidal cross-sectional configuration that includes a vertical front face 21, a horizontal top 22 and bottom surface 23 of the base member.

Still referring to FIGS. 2 through 4, it can also be seen that the wedge unit 12 comprises an elongated wedge body member 30 including a generally flat planar intermediate portion 31 having a generally rectangular extension block element 32 formed on its distal end wherein the extension block element 32 is provided with a vertically aligned threaded bore 33.

In addition, the proximal end of the intermediate portion 31 is rounded and provided with a raised curved wall element 34 and the center of the intermediate portion 31 is provided with an enlarged raised collar element 35 having a stepped shoulder bore 36 formed therein which extends through the intermediate portion 31 of the wedge member 30; and, wherein the stepped shoulder bore 36 is further provided with a peripheral groove 37 whose purpose and function will be described further on in the specification.

As can also be seen by reference to FIGS. 2 through 4, the bottom of the intermediate portion of the wedge member 30 is provided with a downwardly depending elongated wedge element 38 extending along one side of the intermediate portion 31 wherein the wedge element 38 is provided with an angled face 39 adapted to slidably engage the angled rear face 24 of the base member 20.

Still referring to FIG. 2, it can be seen that the locking unit 13 further includes a locking disk member 46 having an elongated slot 47 formed therein; wherein, the disk member 46 is adapted to be captively engaged within the stepped shoulder bore 36 of the raised collar element 35 with the longitudinal axis of the slot 47 aligned generally perpendicular to the longitudinal axis of the wedge element 38 of the wedge 30 to allow the wedge member 30 to be laterally displaced relative to the base member 20.

It should further be noted by reference to FIGS. 2 and 4, that the slot 47 is dimensioned to slidably receive the vertical post element 44 of the locking screw member 40 whereas the peripheral collar 43 will prevent the screw member 40 from being withdrawn relative to the locking disk member 47.

In addition, the locking unit 13 further includes a split ring locking washer 48 that is adapted to be received in the peripheral groove 37 in the stepped shoulder bore 36 of the wedge member 30 to prevent the locking disk 46 to be removed from the wedge member 30.

Furthermore, in the preferred embodiment of this invention illustrated in the drawings, the adjustable wedge clamp apparatus 10 is adapted to be employed in locking channels (not shown) ranging from ⅞″ to 1 ⅛″ in width.

It should also be appreciated that in those instances wherein the lateral displacement of the wedge unit 12 relative to the base unit 11 is not desirable, the locking nut member 40 may be removed from the intermediate portion 31 of the wedge member 30 and reinserted into the threaded aperture 33 in the extension block element 32 provided on the distal end of the intermediate portion 31 of the wedge member 30.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. An adjustable width wedge clamp apparatus for use in locking channels having different dimensions wherein the apparatus comprises
a base unit including an elongated base member provided with a threaded vertical bore and an angled rear face
a wedge unit including a wedge body member having an intermediate portion provided with a wedge element disposed in a downwardly depending relationship relative to one side of the intermediate portion; wherein, the wedge element is provided with an angled face adapted to slidably engage the angled rear face of the base member; and, wherein the intermediate portion is further provided with a stepped shoulder bore; and,
a locking unit including a locking screw member and means for securing the edge unit to the base unit in a laterally adjustable fashion.

2. The apparatus as in claim 1; wherein, the intermediate portion of the wedge body member has a proximal end and a distal end provided with an extension block element having a threaded bore adapted to receive the locking screw member.

3. The apparatus as in claim 1; wherein, said base member has a vertical front wall and horizontal top and bottom surfaces wherein the threaded vertical bore extends through said top and bottom surfaces.

4. The apparatus as in claim 1; wherein, the intermediate portion of the wedge body member is provided with a centrally disposed raised collar element and said stepped shoulder bore extends through said raised collar element.

5. The apparatus as in claim 4; wherein, said locking screw member includes an elongated threaded stem having an outwardly projecting peripheral collar formed on its upper end wherein the peripheral collar is further provided with a vertical post element.

6. The apparatus as in claim 5; wherein, the locking unit further includes a locking disk member dimensioned to be captively engaged in the stepped shoulder bore in the intermediate portion of the wedge body member.

7. The apparatus as in claim 6; wherein, the locking disk member is further provided with an elongated slot dimensioned to slidably receive the vertical post element on the locking screw member.

8. The apparatus as in claim 7; wherein, the stepped shoulder bore is further provided with a peripheral recess and the locking unit further includes a locking washer adapted to be received in said peripheral recess.

9. The apparatus as in claim 7; wherein, the vertical post element on the locking screw member is further provided with a key way.
